(19) United States
(12) Patent Application Publication
(10) Pub. No.: US 2025/0136492 A1
(43) Pub. Date: May 1, 2025

(54) METHOD FOR THE WASTE-FREE PRODUCTION OF MINERAL WOOL INSULATION PRODUCTS

(71) Applicant: IBE Anlagentechnik GmbH, Wien (AT)

(72) Inventor: Victor BARTASHOV, Wien (AT)

(21) Appl. No.: 18/684,039

(22) PCT Filed: Jul. 11, 2022
(86) PCT No.: PCT/EP2022/069265

§ 371 Date: Feb. 15, 2024

(30) Foreign Application Priority Data
Aug. 16, 2021 (AT) A 140/2021

(51) Int. Cl. C03B 3/00; B32B 5/02; B32B 15/14; B32B 15/20; B32B 17/02; B32B 17/06; C03B 37/04; C03C 13/06

(52) U.S. Cl. CPC C03B 3/00; B32B 5/022; B32B 15/14; B32B 15/20; B32B 17/02; B32B 17/061; C03C 13/06; B32B 2307/304; B32B 2311/24; C03B 37/04; C03C 2213/00

(57) ABSTRACT

A method for waste-free production of mineral wool insulation material products, in which insulation material product is produced in a first production area in a plurality of processing steps and granular and fibrous production waste, produced during the storage and transportation of the mineral input materials and after the melt emerges from a cupola, electric arc, or gas-fired melting furnace, are accumulated, shredded and fed to an inductively heated melting furnace in a second production area. The extracted melt is processed with known processing steps to form an insulation material product. The granular and fibrous shredded production waste formed in the second production area is fed to the inductively heated melting furnace as a component of the feed material. Mineral input materials, such as basalt, dolomite and mineral wool waste, which do not originate in either production area, can also be fed to the inductively heated melting furnace.

### DESCRIPTION OF THE INVENTION

The invention relates to an economically advantageous, environmentally friendly and resource-saving method for producing mineral wool insulation products, in which the melt is generated in a production area (A) in a cupola furnace, in an electric arc furnace or in a gas-fired melting furnace (1), fiberized and processed into a mineral wool product. The addition of a production area (B), in which the granular and fibrous production waste from both production areas is melted in an inductively heated melting furnace and processed into a mineral wool product, results in waste-free production. There is no need to briquette or landfill the waste. It is not necessary to add waste to the already produced fibers in a quality-reducing manner. Both production areas are advantageously equipped with a coherent production planning and control system and a common infrastructure, including power and media supply, automation, logistics, raw material preparation, production waste preparation, binder preparation, packaging, order picking, maintenance and repair facilities.

### PRIOR ART

In the production of mineral wool insulation products, raw materials consisting of crushed effusive rocks such as basalt or diabase and small amounts of limestone, dolomite and magnesite as additives are melted and fed to a fiberizing device that generates mineral wool fibers. In most cases, fiberizing is carried out using centrifuges. A centrifuge has three or four driven wheels arranged in a cascade. There are slots in the housing along the circumference of the wheels through which air is blown at high pressure. The melt emerging from the furnace is directed towards the upper centrifugal wheel. The centrifugal force causes some of the material to be formed into fibers and carried away by the air flow. The remaining, unformed part is passed on to the next wheel, where the process is repeated. The heavy melt beads, coarse fibers and fiber structures, which are not carried along by the air flow and make up 10-20% of the melt used, accumulate underneath the centrifuge.

In the nozzle blowing process, fiberizing takes place in a blowing nozzle under the influence of a blown-in air stream. This also produces said waste of a comparable size.

The binder is sprayed into the air-fiber flow coming from the fiberizing device, at the latest at the fiber collecting means. Part of this binder is captured by the fibers; another part is discharged with the exhaust air, and a certain amount is deposited on the walls of the system and must be removed and disposed of at regular intervals.

The air flow with the fibers and the binder is directed onto a gas-permeable fiber collecting means in the form of a perforated drum or a perforated endless belt. The binder-impregnated primary felt, which accumulates on the fiber collecting means, loses its air permeability with increasing thickness and must therefore be transported away from the fiber collecting means with a thickness of only a few centimeters. The binder-impregnated fibers carried along with the exhaust air from the fiber collecting means are separated in a washer.

Several layers of the primary felt are laid on top of each other with the aid of a pendulum laying device, creating the secondary felt with the required thickness. This secondary felt is compacted in a roller compactor and compressed to the final thickness. The roller compactor is followed by the curing furnace in which the binder is cured.

In many production plants, some of the insulation material products are laminated with aluminum foil, depending on the product range. The cured strand is laminated in a laminating machine, which follows the curing furnace.

The edges of the strand are then trimmed and cut to the required dimensions. Large amounts of cutting and dust are formed during this process.

In summary, the following waste can be identified in the production of mineral fiber insulation products: slag, melting beads, coarse fibers, wet fibers, edge trimmings from insulation boards, off-cuts, defective material, unbound fibers and dust from extraction, aluminum foil from lamination and bound binder. Also worth mentioning is the small fraction that arises during in-house processing and transportation of mineral input materials.

In trouble-free operation, the ratio of waste mentioned corresponds to a considerable 15-25% of the raw materials used, which cannot be further reduced with the known prior art.

Apart from the loss of the raw materials used, it is very problematic to dispose of the waste in the form of loose fibers, sections of insulation boards and cured binder. On the one hand, legal regulations are making it increasingly difficult to dispose of this waste in landfill sites, while on the other, ever higher prices are being charged for landfilling. Added to these prices are the costs of briquetting this high-volume, low-density waste, which is necessary in order not to jeopardize the stability of the landfill body.

As the savings achieved through the elimination of disposal costs and the balance of input materials more than outweigh the cost of recycling in the factory, producers of mineral insulation products strive to recycle production waste as much as possible in their own production processes.

In the simplest case, the fibrous waste, if necessary, after shredding, can be blown into the newly produced fibers during or immediately after fiberizing.

U.S. Pat. No. 5,232,638 describes a centrifuge used for fiberizing, in which a continuous pipe is inserted into the drive shaft of at least one centrifugal wheel, the outlet of which is arranged inside the centrifugal wheel. Through this outlet, a mixture of water, ground fibers, binder and occasionally clay is sprayed into the space in which the fibers are formed and wetted with the binder. The ratio of ground fibers in the mixture is approx. 50%, and approx. 50% of the ground fibers shall not be longer than 0.5 mm. The disadvantage of this method is that such short fibers have the harmful properties of dust in the fiber matrix: they increase the thermal conductivity of the insulation material product and reduce its strength for a comparable amount of binder used. Understandably, therefore, there is no information on the ratio of ground fibers in the end product.

U.S. Pat. No. 5,123,949 and EP 0530843 A1 suggest blowing the waste into the air flow containing the primary fibers, which is directed towards the air-permeable fiber collecting means. The maximum possible ratio of waste is estimated at 40%, although the requirement can reach up to 70%. This means that only a certain ratio of the waste can be recycled using this method, as otherwise the quality of the end product would be too greatly impaired.

According to EP 2574693 A1, another embodiment of this method provides for aerogel to be added to the shredded fibrous waste.

EP 3323924 A1 proposes mixing the shredded waste with liquid organic binder and generating two strands of predetermined thickness and density by shaping and compression. In a further process step, the top and bottom sides of the binder-impregnated secondary felt are each bonded to one of these strands. Curing then takes place in a continuous furnace. In addition to recycling the waste, insulation boards with adjustable mechanical properties can be generated.

The extent to which the production waste can be fed back into the material flow of production via the melting unit is also limited by the way the melting unit works at the current prior art.

The most widely used melting unit for the production of mineral wool is the cupola furnace. The cupola furnace is a shaft furnace that is filled from above with coke as fuel, the mineral starting material and the aggregates. Preheated combustion air is blown into the lower part of the furnace. The temperature in the cupola furnace can be increased by introducing pure oxygen or air enriched with oxygen. The resulting molten mineral accumulates at the bottom of the furnace and is drawn off through a siphon. The molten iron, which is produced by the reduction of the iron oxide contained in the basalt, is drained off through a separate opening. Gas-fired furnaces, which use natural gas or mineral oil as an energy source, have a similar design.

The exhaust gases from the cupola furnace must be fed into a CO post-combustion process. Filters are used to separate the dust particles carried along.

It is known that small-grained and fibrous material in the cupola furnace obstructs the process-relevant vertical gas flow and ultimately brings the melting process to a standstill due to clogging. Due to its low density and high flow resistance, the fibrous material would also be carried along with the extracted gases and clog the filters. It is therefore very problematic to recycle both the small-grained and the fibrous waste by feeding it into the cupola furnace together with the lumpy mineral material.

According to US 2008/0256981 A1, 5-20% of the mineral feedstock can be fed into a cupola furnace in the form of cullet, which has previously been generated by melting the waste in a separate furnace. This amount is still too small to be able to return the entire amount of production waste to the production material flow.

The prior art is to mix the mineral wool production waste with cement and water, produce larger shaped bricks (also known as briquettes and pellets) and feed these into the cupola furnace after a curing time of at least 48 hours.

The report “Decarbonization Options for the Dutch Stone Wool Industry” (PBL Netherlands Environmental Assessment Agency, Publication Number 3722, 12 Dec. 2019), shows that one of the largest producers of mineral wool insulation products, Rockwool NL B.V., returns 150,000 t/a of waste in the form of shaped bricks to the cupola furnaces for the production of 300,000 t/a of end product. This requires 90,000 t/a of cement. In total, the shaped bricks make up 42% of the input material for the cupola furnaces.

The obvious disadvantages of this method are the great technical effort involved and the high additional costs for the cement. Despite the addition of cement, the strength of the shaped bricks is lower than that of the mineral raw material, especially at temperatures of 400-500° C. and above. This is also due to the water-repellent (hydrophobic) component contained in the binder, which significantly reduces the effect of the cement. For this reason, the use of shaped bricks requires greater effort in controlling the furnace to prevent it from clogging.

Within the limited potential of briquetting, the developments are essentially aimed at the substances used in addition to the cement, which can advantageously increase the strength of the shaped bricks and reduce the ratio of the comparatively expensive cement. Examples include: WO 92/04289 (addition of blast furnace slag and an alkaline additive in the form of calcium oxide or calcium hydroxide), WO 97/22563 (addition of alumina), WO 2005/073139 A2 (addition of used blasting agents), WO 2006/015647 A1 (addition of dried sewage sludge), US 2014/0159272 A1 (addition of clay brick fragments), DE 102015120721 A1 (addition of surfactants and organic plasticizers).

A method for recycling production waste known as PAROC-WIM was developed by Paroc Group OY AB (LIFE02 ENV/FIN/000328). It consists of shredding the production waste to a grain size of less than 10 mm and blowing it into the cupola furnace via the oxygen lances. In a pilot plant, it was demonstrated that at least the waste produced at the fiberizing device, i.e. a comparatively coarse-grained material, can be completely recycled in this way. It was also demonstrated that up to 10% of the input material, based on the mass of the final mineral wool product, can consist of shredded production waste that has been blown in. In addition to the saving of coke in the order of 7%, the reduction of SO₂ emissions is cited as an advantage of this method, which is all the more significant in view of the approx. 50% increase in values when the waste is added in the form of shaped bricks.

In an electric arc furnace, there can be no clogging due to the design. However, this type of furnace is also equipped with an extraction system, which means that fibrous material would quickly clog the filters. Despite the possibility of being able to return at least small-grained material, this method of generating the melt has not yet found widespread use in the production of mineral wool.

In a cyclone furnace, the feed material is intensively mixed with natural gas or powdered fuels and the combustion air so that the heat of combustion is used as fully as possible for the melting process. WO 2008/086990 A1 confirms that a costly enrichment of the combustion air with oxygen is necessary to generate the high temperatures required for melting basalt. In addition, the construction must be designed and the furnace operated in such a way that the feed material melts as quickly as possible so as not to be carried along with the exhaust gas flow. Nevertheless, compared to the cupola furnace, considerably more heat is dissipated with the exhaust gas flow and considerably more particles are discharged. This type of furnace must therefore be equipped with a complex heat recovery system, comparatively large filters and a device for returning the filter material to the furnace. These disadvantages outweigh the advantage of feeding fine-grained feed material, and this type of furnace is therefore rarely found in the production of mineral wool insulation products.

WO 2013/083464 A1 proposes a cyclone melting furnace with three additional cyclones for waste gas treatment, which can also melt fly ash from external sources in addition to production waste. A disadvantage of this furnace is that the three additional cyclones and the associated piping must be lined with refractory material. The realistic ratio of mineral wool waste in the feed material is stated to be 20%, which, according to the facts already explained, is too low to enable waste-free production.

In EP 0389314 A1, WO 2006/018582 A1 and US 2008/0256981 A1, it is proposed to feed pure oxygen or oxygen-enriched air with an oxygen content of at least 40% by volume into a brick-lined furnace via bottom nozzles in order to convert production waste into a melt. The required heat is provided by burning the organic binder contained in the waste and by burning the gaseous fuel supplied. The disadvantage of such a furnace is the high cost of pure oxygen, which must be used in over-stoichiometric quantities. In addition, no advantageous solution is described for preventing the discharge of fibers from the furnace with the exhaust gases.

It is known that mineral material can be heated and melted in an induction furnace if the crucible in which the molten material is located is made of electrically conductive material.

In an induction furnace designed as a continuous furnace, it is possible to heat and liquefy the feed material very quickly, i.e. within a few minutes. In this case, the volatile components, in particular the heavy metals, virtually do not evaporate. This is a significant advantage of the induction furnace in the inertization of filter dusts containing heavy metals through vitrification. In the conventional tanks of large glass furnaces, the dwell times are several hours. The heavy metals that inevitably evaporate must be filtered out of the exhaust gases in an additional stage and sent for disposal or recycling.

WO 93/18868 describes a method for inertization by vitrification in which melting takes place in an inductively heated tank furnace. Due to the long dwell time of the molten material in the furnace, the return of the heavy metal-containing dusts is a complex part of this method in terms of plant engineering.

CH 680656 A5 shows an example of how inductive heating can be used advantageously in inertization by vitrification, in that the molten material is liquefied within a very short time in the inductively heated continuous furnace and is solidified very quickly in a cooling or quenching device after leaving the furnace. Accordingly, the crucible made of electrically conductive material has a very simple, unspecified shape. In order to increase the input of energy, an additional electrical direct or indirect resistance heater is provided and, in a further embodiment, an additional gas or oil heater.

WO 2019/094536 A1 describes a melting furnace for generating a melt for the production of mineral wool, which can process mineral wool waste and melting beads. The melting furnace is heated with plasma, natural gas or electricity. Additional energy can be supplied by an induction coil by heating liquid metal in a trough forming the lower part of the furnace. Continuous melting operation of such a furnace with exclusively inductive heating is not possible because the heat flow from the molten metal to the molten glass and, in particular, from the molten glass to the feedstock is too low. A suitable method for increasing the heat transfer from the mineral melt to the fibrous input material floating on it to the level required for the production of mineral wool is not conceivable.

CN 106892550 A describes an induction furnace for generating a melt for subsequent fiberizing, in which the mineral input material is heated in a metallic cylinder enclosed in a ceramic crucible. The two outlets for the reduced iron and the mineral melt are arranged laterally. The required dimensioning of these outlets, taking into account the high radiant heat, means that the winding of the induction coil can only be distributed unevenly over the height of the metallic cylinder. In addition, it is not possible to regulate the energy input by adjusting the height of the induction coil. Last but not least, the side outlets are an obstacle when replacing the ceramic crucible.

For trouble-free operation of the fiberizing device and the lowest possible contamination of the mineral wool product with melting beads, it is important that the melting furnace provides a homogeneous melt in terms of chemical composition, viscosity and crystallization behavior. To achieve this, it is necessary to heat the melt in the furnace for a certain period of time to a temperature of approx. 1700-1750° C., at which the high-melting phases are certainly liquefied. After mixing and homogenization of the completely melted mineral input material, it is advantageous to lower the temperature of the melt to temperatures in the range 1420-1480° C., at which the yield of fibers produced at the fiberizing device is highest, the ratio of long fibers is highest and the ratio of waste in the form of slag and melt beads is lowest.

While such targeted temperature control is not possible in the electric arc furnace due to its design, temperatures of over 1600° C. cannot be achieved in the cupola furnace, even with the injection of hot blast or pure oxygen.

U.S. Pat. No. 4,174,462 A shows how a temperature profile of the mineral melt can be specifically set along the path from the upper feed opening to the lower outlet opening in an induction-heated furnace. In a hollow graphite cylinder heated with several successive induction coils, round graphite plates are arranged, which are provided with holes, channels and recesses. The number and arrangement of these plates, each of which has its own design with holes, channels and recesses, can be used to influence the heat transfer to the molten material at the various height sections and thus also the temperature of the melt. In addition, the plates cause the melt to be mixed, thereby achieving homogeneity.

AT 516735 B1 describes an inductively heated furnace for generating a melt in the production of mineral wool fibers, which consists of two chambers that can be heated independently of each other and are connected to each other by at least one channel. The graphite susceptor, consisting of mechanically machined parts, provides the melt with a non-rectilinear path, which allows the temperature of the melt in the furnace to be influenced over time.

A further design of the susceptor allows the molten iron resulting from reducing reactions to be removed through a separate outlet opening at the bottom of the furnace, as described in AT 519230 B1.

According to AT 519235 A4, a further development is that the inductively heated susceptor has at least two channels connecting the upper feed opening and the lower outlet opening. The resulting melt flows through several vertical channels, which have a cross-sectional constriction at the lower end. In this area, the melt heats up to approx. 1500° C. In the subsequent area, in which horizontal structures of the susceptor force a radial movement of the melt, it is heated to temperatures between 1700 and 1750° C., whereby the heavy melting components of the feed material are also liquefied and mixed with the rest of the melt to form a homogeneous phase. The melt then accumulates in a chamber surrounded by the horizontal structures of the susceptor, where it can cool to temperatures of 1420-1480° C., which are optimal for fiberizing the melt after it exits the furnace.

If the susceptor, which is preferably made of graphite, is provided with vertical slots on the side facing the furnace wall, as described in AT 521245 A4, the area of inductive heating can be shifted inwards, to an area, which contacts the material to be melted, further away from the inductor surrounding the furnace wall. The arrangement and dimensions of the slots can be used to influence the energy input over the height of the furnace in the desired way.

It is obvious that mineral input material can only be fed into an induction-heated continuous furnace with susceptor, which is provided with channels, up to a certain grain size, typically 12 mm. This requirement means that not only fragmented basalt and dolomite, but also waste from insulation material production such as fused beads, offcuts, fibers and dust can be melted in such a furnace in any desired ratios.

### OBJECT OF THE INVENTION

At present, it is not possible to prevent the generation of waste in the form of slag, melting beads, coarse fibers and fiber aggregates during the fiberizing of the melt in a centrifuge or with the nozzle blowing process in the production of mineral wool insulation products with reasonable technical effort. Further waste accumulates in the form of loose fibers, cuttings, dust, possibly aluminum foil and bound binder.

With the established methods for producing mineral wool insulation products, the generation of considerable amounts of production waste, typically 15-25% of the mineral raw materials used, cannot be avoided even in trouble-free operation.

The conventional methods aim to return the production waste to the material cycle of production to the extent that it does not impair the stability of the melting process and the quality of the end product. In this way, the loss of mineral raw materials used is limited and the costs of sending the waste to landfill are reduced.

On the basis of the methods listed, it has been sufficiently demonstrated that it is not possible in most cases with the known prior art to return the entire amount of waste formed to the material flow of production for the purpose of waste-free production of mineral wool insulation products. The prior-art melting units cupola furnace and electric arc furnace can only be fed with a limited amount of fibrous waste because this clogs the exhaust filters and, in the case of the cupola furnace, also the melting shaft. The ratio of cement-bound briquettes and cullet, which are generated from separately melted production waste and fed into the cupola furnace, is also limited. In addition, only a limited amount of shredded production waste can be added to the newly produced fibers because this reduces the insulating properties and mechanical strength of the insulation material product in a disadvantageous way.

The technical literature and the trends shown by the relevant patents indicate that the leading producers of mineral wool insulation materials are focusing their development work on refining or adapting known methods for returning production waste to the melting furnace or adding it to the newly generated fiber stream.

Based on the prior art, the invention is based on the task of providing a method with which it is possible to overcome the limitations of known and established methods for producing mineral wool insulation products and to return the entire amount of production waste to the material cycle of production without impairing the quality of the insulation material products generated.

According to the invention, the task is solved by a method for producing insulation material products, in which a first production area, in which mineral input material is melted in a cupola furnace or electric arc furnace or gas-fired melting furnace and the melt drawn off from this melting furnace is fiberized in a fiberizing device and the mineral fibers obtained are processed into an insulation material product in several processing steps with the formation of production waste, supplemented by a second production area in which a melt is generated in an inductively heated, in particular exclusively inductively heated, melting furnace and processed into an insulation material product using the known processing steps, the shredded granular and fibrous production waste from both production areas being fed to the inductively heated, in particular exclusively inductively heated, melting furnace.

The production waste includes
small-grained mineral material formed during storage and transportation of the raw materials and cannot be used in a cupola furnace;
melting beads, slag as well as coarse fibers and fiber structures formed in the area of the fiberizing device;
binder-soaked mineral fibers in aqueous solution, mineral fibers moistened with binder and bound binder formed in the area of the fiber collecting means;
Edge trimmings and offcuts, including material laminated with aluminum;
Dust, especially from the saws;
defective insulation material product;
adhering paper and cardboard as well as components of plastic packaging material which cannot be removed from the waste stream without leaving residues.

An essential feature of the invention is that feed material with any ratio of granular and fibrous production waste can be fed into the inductively heated melting furnace.

Since the feed material of the inductively heated melting furnace should not exceed a grain size or bale size of typically 12 mm, the various types of production waste are shredded to a grain size or bale size of less than 12 mm using suitable known methods and devices. In a preceding process step, the water must be removed from the binder-impregnated fibers in an aqueous solution, for which a centrifuge, for example, is suitable. In accordance with the nature of the invention, the shredded production waste is temporarily stored in at least one silo before being fed into the inductively heated melting furnace. An advantageous embodiment provides for the use of at least one device operating on the principle of a mixing silo.

A further embodiment of the invention provides for additional mineral input materials, such as basalt and dolomite, to be fed into the inductively heated melting furnace. Since production waste and mineral input materials can be fed to the inductively heated melting furnace in any desired ratios, it is possible to produce an insulation material product in the second production area with the inductively heated melting furnace independently of the quantity of production waste from both production areas. This includes the possibility of compensating for variable amounts of production waste that form and increasing the production of the insulation material product if necessary.

Another application involves feeding the induction-heated melting furnace with mineral wool waste that does not originate from either of the two production areas. In view of the constantly increasing costs for the landfilling of mineral wool waste, the method according to the invention thus opens up an additional source of income if external production waste and/or mineral wool waste from the construction sector is used as feed material for the induction-heated melting furnace.

In an advantageous application of the method, an insulation material product is produced with an alternating sequence of melts with a high ratio (e.g. more than 40% by weight) of the shredded production waste from the first production area in the feed material of the induction-heated melting furnace and melts with a low ratio (e.g. less than 20% by weight) of the shredded production waste of the first production area in the feed material of the inductively heated melting furnace, whereby the accumulation of production waste in the first production area above the predetermined level is prevented by determining the duration of such melts and the ratios of the production waste.

The invention is particularly advantageous if the two production areas have a coherent production planning and control system and a common infrastructure, including power and media supply, automation, logistics, raw material preparation, production waste preparation, binder preparation, packaging, picking, maintenance and repair facilities.

According to the invention, the induction-heated melting furnace is fed via at least one conveying and dosing device.

In a preferred embodiment of the invention, the feed material fed to the inductively heated melting furnace is transported by gravity from the upper feed opening to a lower outlet opening of the melting furnace through at least two channels of an inductively heated susceptor and is heated and melted in this way.

With the inductively heated, in particular exclusively inductively heated melting furnace, a continuous melt stream is generated from granular and fibrous feed material with a grain or bale size of less than 12 mm, this is fiberized in a fiberizing device and the mineral fibers obtained are processed into an insulation material product in several processing steps.

### EXAMPLE EMBODIMENT

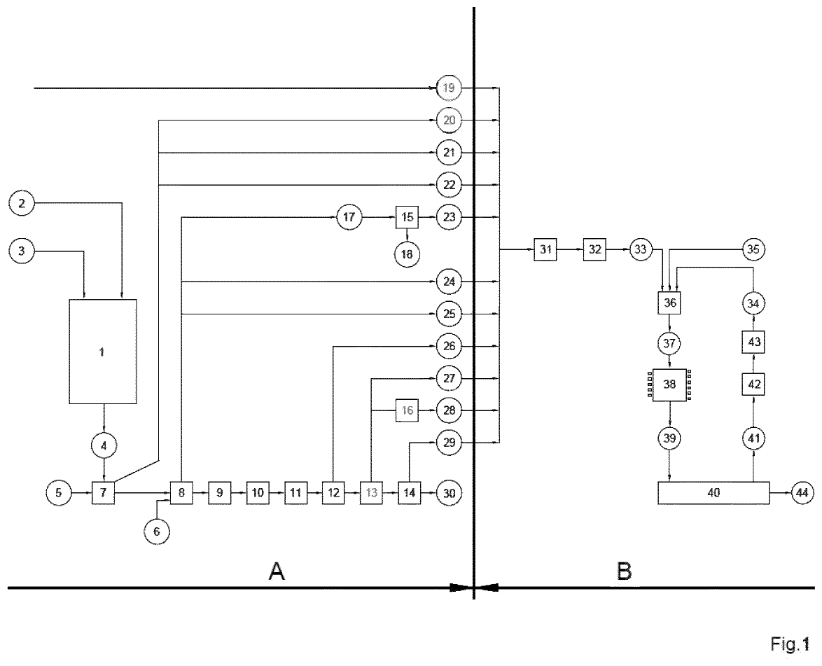

The method according to the invention will be described by way of example by linking a first production area (A) with a second production area (B), each of which is shown as a block diagram in FIG. 1. In the first production area (A), an insulation material product (30) is produced in accordance with the known prior art, in which the melt (4) to be fiberized is generated using a known melting furnace (1), which can be a cupola furnace, an electric arc furnace or a gas-fired melting furnace. Mineral input material (2) and aggregates (3) are fed to the melting furnace (1) as feed material. In the case of a cupola furnace, coke is the dominant additive.

The essential feature of the second production area (B) is an inductively heated melting furnace (38) with the property of being able to continuously melt granular and fibrous feed material with a grain size of less than 12 mm suitable for the production of mineral wool insulation products without restrictions, whereby the generated melt meets all requirements for the production of a high-quality insulation material product.

In the first production area (A), the insulation material product (30) is generated from the melt (4) in processing steps (7)-(14), whereby the production waste (19)-(29) is formed. In the second production area (B), the known processing steps for producing an insulation material product (44) are summarized with the number (40) and the granular and fibrous production waste formed in the process is summarized with the number (41).

When the coarse mineral input materials (2) are stored and transported in the first production area (A), a small fraction (19) is produced. As this must not be fed into the cupola furnace, it must be treated as production waste.

In the fiberizing device (7), the melt (4) is fiberized and carried along with an air flow (5), whereby melt beads (20), slag (21) and coarse fibers and fiber structures (22) that do not reach the fiber collecting means (8) are formed as production waste.

In the fiber collecting means (8), in which the liquid binder (6) is added to the produced fibers, production waste is produced in the form of binder-soaked mineral fibers in aqueous solution (17), mineral fibers (24) moistened with binder and bound binder (25), which accumulate over time and must be removed regularly.

The binder-containing water (18) is separated in a dewatering device (15), which may be a centrifuge, for example. The dewatered production waste (23) can then be further processed together with the other production waste.

If small amounts of production waste are occasionally formed in the pendulum unit (9), in the compression unit (10) and in the curing furnace (11), these can be assigned to one of the categories (19)-(29).

In the laminating unit (12), the cured strand is covered on one or both sides with a film, preferably made of aluminum. Laminated pieces (26) are formed as production waste.

The cured strand is usually trimmed and cut to the required dimensions using saws (13). The production waste consists of edge trim and offcuts (27) as well as dust (28), which is separated from the air flow using a filter (16).

In the final quality control and during packaging of the insulation material product (30) in the packaging station (14), defective insulation material product (29) is sorted out. Production waste (29) also includes adhering paper and cardboard as well as components of plastic packaging material that cannot be removed without leaving residue.

All granular and fibrous production waste from (19)-(29) of the first production area (A) and (41) of the second production area (B) must be shredded if they exceed a grain size or bale size of 12 mm. Grinders and shredders listed with the numbers (31) and (42) are preferably used. The number and type of shredding units are determined in accordance with the sufficiently known prior art. The shredded production waste (33) and (34) are mixed and temporarily stored. In accordance with the nature of the invention, the mixtures of the production waste (33) and (34) comprise, in any desired ratios, the granular and fibrous production waste formed in the first production area (A) and in the second production area (B), respectively.

The stores (32) and (43) may comprise one or more silos and/or mixing silos, wherein each silo and/or mixing silo may be assigned one or more of the categories of production waste designated by items (19)-(29) and (41).

The production waste designated by items (19)-(29) and (41) is transported using conventional conveying devices, such as screw conveyors, conveyor belts, pneumatic transport and containers that are moved by internal means of transport.

The feed material (37) is fed to the inductively heated melting furnace (38) in the second production area (B) via at least one dosing device (36). The feed material (37) can contain any ratio of the granular and fibrous production waste (19)-(29) from the first production area (A) and the granular and fibrous production waste (41) from the second production area (B). The waste-free production occurs because all granular and fibrous production waste formed in the two production areas (A) and (B) can be processed into an insulation material product (44) in the second production area (B).

In order to be able to produce the insulation material product (44) independently of the amount of production waste (19)-(29) formed in the first production area (A), mineral input material (35), such as basalt and dolomite, is fed to the inductively heated melting furnace (38) in the second production area (B). In this way, variable quantities of production waste can be compensated for and the production of the insulation material product (44) in the second production area (B) can be kept constant in accordance with the design of the inductively heated melting furnace (38).

Mineral input material (35) of the inductively heated melting furnace (38) can also be mineral wool waste which does not originate in either of the two production areas (A) and (B). This waste includes, for example, production waste from other producers of insulation material products and offcuts of insulation material products that form in the construction sector.

Due to the limited possibilities of a cupola furnace (1) to process small-grained feed material (2), the production of an insulation material product (44) in the second production area (B) is to be mentioned as an embodiment example of the invention, in which the feed material (37) fed to the inductively heated melting furnace (38) consists of more than 40% by weight of the shredded production waste (33) of the first production area (A).

Another example of the combination of the two production areas (A) and (B) consists in the production of the insulation material product (44) in the second production area (B) with an alternating sequence of melts with a ratio of more than 40% by weight of the shredded production waste (33) of the first production area (A) in the feed material (37) of the inductively heated melting furnace (38) and melts with less than 20% by weight of the shredded production waste (33) of the first production area (A) in the feed material (37) of the inductively heated melting furnace (38), wherein the accumulation of production waste (19)-(29) of the first production area (A) above a predetermined level is prevented by determining the duration of the melting and the ratios of the production waste.

The potential of the invention can be demonstrated by means of an inductively heated melting furnace (38) in the second production area (B) with an annual output of 25,000 tons. Assuming an average waste quantity of 25% in each of the two production areas (A) and (B), 75,000 t/a of mineral input material (2) can be transformed into mineral wool insulation material products (30) and (44) without having to briquette the production waste, add it to the already produced fibers or send it to a landfill. In this case, the feed material (37) of the induction-heated melting furnace (38) consists of 18,750 t/a of shredded production waste (33) from the first production area (A) and 6,250 t/a of shredded production waste (34) from the second production area (B).

If an existing first production area (A), in which a cupola furnace or an electric arc furnace or a gas-fired melting furnace (1) with a certain melting capacity is installed, is supplemented by a second production area (B), which has an inductively heated melting furnace (38) with the same melting capacity, the annual production of insulation material products can be doubled and at the same time all production waste can be utilized, so that briquetting is no longer necessary and no waste has to be landfilled. This means that such production is waste-free and does not contain any processing steps that serve to recycle production waste, which is known to impair the quality of the mineral wool insulation material product.

Since the melting capacity of one or more furnaces (1) in the first production area (A) can be so large that the amount of production waste (19)-(29) significantly exceeds the practicable melting capacity of an inductively heated melting furnace (1), one embodiment of the invention provides for the use of more than one inductively heated melting furnace (38) in the second production area (B). For example, with a production in the first production area (A) of 300,000 t/a of insulation material products (30) with 60,000 t/a of production waste (19)-(29), it is expedient to operate three inductively heated melting furnaces (38) in the second production area (B), each with a melting capacity of about 27,000 t/a, assuming that the ratio of production waste is 25%.

The method according to the invention does not exclude the case that production waste from the categories (19)-(29) of the first production area (A) is returned to the material flow of the production of the insulation material product (30) in this production area according to one or more of the conventional methods. Examples include generating briquettes and feeding them into the furnace (1), and adding shredded production waste to the newly produced fibers in the area between the centrifuge (7) and the fiber collecting means (8). Such a method can be advantageous if the second production area (B) is added to an already existing first production area (A), preferring the lowest possible investment costs to the greatest possible advantages of completely dispensing with the conventional methods of returning the production waste to the material flow of production.

The processing steps in the second production area (B) summarized in (40) include fiberizing the melt in a fiberizing device and generating a primary felt in a fiber collecting means. In a further preferred embodiment of the invention, it is provided that, for the purpose of reducing investment costs, a reduced range of insulation material products (44) and/or insulation material products (44) which are less complex to produce are generated in the second production area (B) with fewer processing steps than in the first production area (A). These can be, for example, loose rock wool for tamping applications and wire mesh mats.

The processing steps shown in FIG. 1 for generating a melt (4) and (39) as well as (7)-(14) and (40) for producing the insulation material products (30) and (44) require a minimum of production planning and control and automation technology in accordance with the known prior art. The invention includes for the two production areas (A) and (B) a coherent production planning and control as well as a common infrastructure, including power and media supply, automation, logistics, raw material preparation, production waste preparation, binder preparation, packaging, commissioning, maintenance and repair facilities.

For generating a mineral melt (39), the inductively heated melting furnace (38) has a susceptor with at least two channels through which the feed material (37) is transported by gravity from an upper feed opening to a lower outlet opening of the melting furnace and is heated and melted in this way.

Granular and fibrous feed material (37) with a grain or bale size of less than 12 mm is fed to the inductively heated, in particular exclusively inductively heated, melting furnace (38) and the drawn-off melt is processed into an insulation material product (44) using the known processing steps (40).

1. A method for the waste-free production of mineral wool insulation products, in which, in a first production area (A), mineral input material (2) and aggregates (3) are fed to a cupola furnace or an electric arc furnace or a gas-fired melting furnace (1), the feed material is melted in this melting furnace (1), the melt (4) drawn off from this melting furnace (1) is fiberized in a fiberizing device (7) and the mineral fibers obtained are processed in a plurality of processing steps (8)-(14) to form an insulation material product (30), wherein the granular and fibrous production waste (19)-(29) which is produced during storage and transport of the mineral input material (2) and after the melt (4) has emerged from this melting furnace (1), in particular during fiberizing (7) and in the subsequent processing steps (8)-(14), is shredded, mixed and fed in a second production area (B) to an inductively heated, in particular exclusively inductively heated, melting furnace (38) as a component (33) of the feed material (37), the melt (39) drawn off from the inductively heated melting furnace (38) is processed with the known processing steps (40) to form an insulation material product (44), the granular and fibrous production waste formed in the processing steps (40) in the second production area (B) being fed to the inductively heated melting furnace (38) as a component (34) of the feed material (37).

2. The method according to claim 1, wherein the first production area (A) comprises more than one cupola furnace or electric arc furnace or gas-fired melting furnace (1) and/or the second production area (B) comprises more than one inductively heated melting furnace (38).

3. The method according to claim 1, wherein the two production areas (A) and (B) have a coherent production planning and control system and a common infrastructure, including the power and media supply, the automation, the logistics, the raw material preparation, the production waste preparation, the binder preparation, the packaging, the commissioning, the maintenance and repair facilities.

4. The method according to claim 1, wherein small-grained mineral material, which is produced during storage and transport of the coarse-grained raw materials (2) and cannot be used in a cupola furnace (1), is accumulated as production waste (19) and fed to the inductively heated melting furnace (38).

5. The method according to claim 1, wherein fiberizing the melt (4) in the fiberizing device (7) with an air flow (5) comprises generating an air-fiber flow which is directed towards a fiber collecting means (8), on or in which the mineral fibers are collected, melt beads (20), slag (21), coarse fibers and fiber structures (22) which do not reach the fiber collecting means (8) being collected separately from the mineral fibers as production waste and fed to the inductively heated melting furnace (38).

6. The method according to claim 1, wherein the processing steps for processing the mineral fibers into the insulation material product (30) comprise spraying the mineral fibers with a binder (6) and collecting the binder-impregnated mineral fibers on a fiber collecting means (8) for generating a primary felt, wherein binder-impregnated mineral fibers in aqueous solution (17) and binder-moistened mineral fibers (24) are carried along as production waste with an exhaust air from the fiber collecting means (5), separated from the exhaust air, accumulated and fed to the inductively heated melting furnace (38).

7. The method according to claim 6, wherein the binder-containing water (18) is removed from the production waste in aqueous solution (17) in a dewatering device (15) by a mechanical method down to a residual moisture content of less than 20% and the dewatered production waste (23) is accumulated and fed to the inductively heated melting furnace (38).

8. The method according to claim 1, wherein the processing steps for processing the mineral fibers into the insulation material product (30) comprise spraying the mineral fibers with a binder (6) and collecting the binder-impregnated mineral fibers on a fiber collecting means (8) for generating a primary felt, wherein cured binder (25) deposited in the fiber collecting means (8) is removed, accumulated and fed to the inductively heated melting furnace (38).

9. The method according to claim 1, wherein the processing steps for processing the mineral fibers into the insulation material product (30) comprise stacking several layers of the primary felt to generate a secondary felt in a pendulum unit (9), compressing the secondary felt in a compressing unit (10), passing through a curing furnace (11) for generating a cured strand and laminating with aluminum foil the cured strand in a laminating machine (12) and trimming the edges of the strand and sawing to the desired dimensions with saws (13), wherein laminated offcut (26), edge section and offcut (27) as well as dust (28) are formed as production waste, which is accumulated and fed to the inductively heated melting furnace (38).

10. The method according to claim 1, wherein the dust (28), which is formed in particular during trimming and cutting of the hardened strand by means of saws, is accumulated with at least one filter (16), collected and fed to the inductively heated melting furnace (38).

11. The method according to claim 1, wherein the processing steps for processing the mineral fibers into the insulation material product (30) comprise the quality control and the packaging of the insulation material product (30) in the packaging station (14), defective insulation material product (29) being formed, which is accumulated and fed to the inductively heated melting furnace (38).

12. The method according to claim 1, wherein the production waste (19)-(29) of the first production area (A) is selected in any desired ratios from small-grained mineral input material (19), melting beads (20), slag (21), coarse fibers and fiber structures (22), dewatered fibers (23), fibers (24) moistened with binder, cured binder (25), laminated offcuts (26), edge trimmings and offcut residues (27), dust (28) and defective end product (29).

13. The method according to claim 1, wherein the production waste (19)-(29) of the first production area (A), the grain size or bale diameter of which exceeds 12 mm, is shredded to a grain size or bale diameter of less than 12 mm in at least one shredding unit (31) before being fed into the inductively heated melting furnace (38).

14. The method according to claim 1, wherein the production waste (19)-(29) of the first production area (A) is mixed in at least one device (32) operating according to the principle of a mixing silo before being fed into the inductively heated melting furnace (38) and is temporarily stored as a mixture of shredded production waste (33).

15. The method according to claim 1 in which a melt (39) is generated in a second production area (B) in an inductively heated melting furnace (38) and is processed into an insulation material product (44) using the known processing steps (40), the corresponding granular and fibrous production waste (41) being formed in the processing steps (40), wherein granular and fibrous production waste (41) is accumulated, shredded with at least one shredding device (42), temporarily stored in at least one storage tank (43) and fed to the inductively heated melting furnace (38) as shredded feed material (34).

16. The method according to claim 15, wherein the processing steps (40) include at least the fiberizing of the melt (39) with a fiberizing device and the accumulation of the produced fibers with a fiber accumulation device.

17. The method according to claim 15, wherein the processing steps (40) are limited to those which are necessary for generating a simple insulation material product such as loose mineral wool.

18. The method according to claim 1, wherein the feed material (37) fed to the inductively heated melting furnace (38) is selected in any desired ratios from the production waste (33) of the first production area (A), the production waste (34) of the second production area (B) and mineral input materials (35).

19. The method according to claim 18, wherein the mineral input materials (35) are selected in any desired ratios from basalt, dolomite, diabase and mineral wool waste which do not originate in either of the two production areas (A) and (B).

20. The method according to claim 1, wherein, the feed material (37) fed to the inductively heated melting furnace (38) consists of more than 40% by weight of the shredded production waste (33) of the first production area (A).

21. The method according to claim 1, wherein the production of the insulation material product (44) in the second production area (B) is carried out with an alternating sequence of melts with a ratio of more than 40% by weight of the shredded production waste (33) of the first production area (A) in the feed material (37) of the inductively heated melting furnace (38) and melts with less than 20% of the shredded production waste (33) of the first production area (A) in the feed material (37) of the inductively heated melting furnace (38), wherein the accumulation of production waste (19)-(29) of the first production area (A) above a predetermined level is prevented by determining the duration of the melting and the ratios of the production waste.

22. The method according to claim 1, wherein mineral input materials (35) and production waste (34) with a grain size or a bale diameter of less than 12 mm are fed to the inductively heated melting furnace (38).

23. The method according to claim 1, wherein the feed material (37) is fed to the inductively heated melting furnace (38) via at least one dosing device (36).

24. The method according to claim 23, wherein the feed material (37) fed to the inductively heated melting furnace (38) is transported by gravity from an upper feed opening to a lower outlet opening of the melting furnace (38) through at least two channels of an inductively heated susceptor and is heated and melted in this way and the resulting melt emerges from the melting furnace (38) as a continuous stream.
